(19) United States
(12) Patent Application Publication
(10) Pub. No.: US 2026/0014672 A1
(43) Pub. Date: Jan. 15, 2026

(54) Adjustable Pair Of Locking Pliers

(71) Applicant: Mitchell Ireland, Huntington, WV (US)

(72) Inventor: Mitchell Ireland, Huntington, WV (US)

(21) Appl. No.: 18/769,963

(22) Filed: Jul. 11, 2024

(51) Int. Cl. B25B 7/04; B25B 7/12; B25B 7/16

(52) U.S. Cl. CPC B25B 7/04; B25B 7/12; B25B 7/16

(57) ABSTRACT

An adjustable pair of locking pliers has a fixed handle including an upper jaw, a lower jaw pivotably connected to the fixed handle, a movable handle pivotably connected to the lower jaw, and an adjustment assembly. The adjustment assembly permits adjustment of the gripping space between the upper and lower jaws when in a clamping position. The adjustment assembly includes an adjustment screw positioned in an end portion of the fixed handle and a locking piece operatively connecting the movable handle to the adjustment screw and designed to releasably lock the upper and lower jaws under tension in the clamping position. The adjustment screw includes a threaded body and a handle positioned transverse to the threaded body and designed to be manually grasped and twisted by a user to advance and retract the threaded body to release the upper and lower jaws from a locked state.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to locking pliers and more particularly pertains to a new adjustable pair of locking pliers for easier release of tension when in the locked position using an adjustment screw with a handle.

### (2) Description of Related Art Including Information Disclosed Under 37 CFR 1.97 and 1.98

The prior art relates to locking pliers. The prior art, as best understood, does not disclose an adjustable pair of locking pliers for easier release of tension when in the locked position using an adjustment screw with a handle.

### BRIEF SUMMARY OF THE INVENTION

An embodiment of the disclosure meets the needs presented above in an adjustable pair of locking pliers generally comprising a fixed handle that includes an upper jaw, a lower jaw pivotably connected to the fixed handle by a pivot joint, a movable handle pivotably connected to the lower jaw, and an adjustment assembly. The adjustment assembly is designed to permit adjustment of the gripping space between the upper and lower jaws when in a clamping position. The adjustment assembly includes an adjustment screw positioned in an end portion of the fixed handle and a locking piece operatively connecting the movable handle to the adjustment screw and designed to releasably lock the upper and lower jaws under tension in the clamping position on an object. The adjustment screw includes a threaded body and a handle positioned transverse to the threaded body and designed to be manually grasped and twisted by a user to advance and retract the threaded body to both set the gripping space and release the upper and lower jaws from a locked state.

Unlike standard locking pliers, the adjustable pair of locking pliers does not utilize a release lever. Standard locking pliers usually include a release lever that sits in a nested relationship with the movable handle and is depressible to break the locked condition of the locking piece, which allows the user to release the tension on the upper and lower jaws and thereby release the locking engagement. However, often the stresses on the locking piece can be quite high and actuating the release lever can be difficult, especially if the locking pliers are worn or the user has lower hand strength. The adjustable pair of locking pliers provides an alternative to the release lever, thereby simplifying construction and improving performance.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of an adjustable pair of locking pliers according to an embodiment of the disclosure.

FIG. 2 is a side view of an embodiment of the disclosure.

FIG. 3 is a top view of an embodiment of the disclosure.

FIG. 4 is a perspective view of an embodiment of the disclosure.

FIG. 5 is a side view of an embodiment of the disclosure.

FIG. 6 is a perspective view of an embodiment of the disclosure in use.

### DETAILED DESCRIPTION OF THE INVENTION

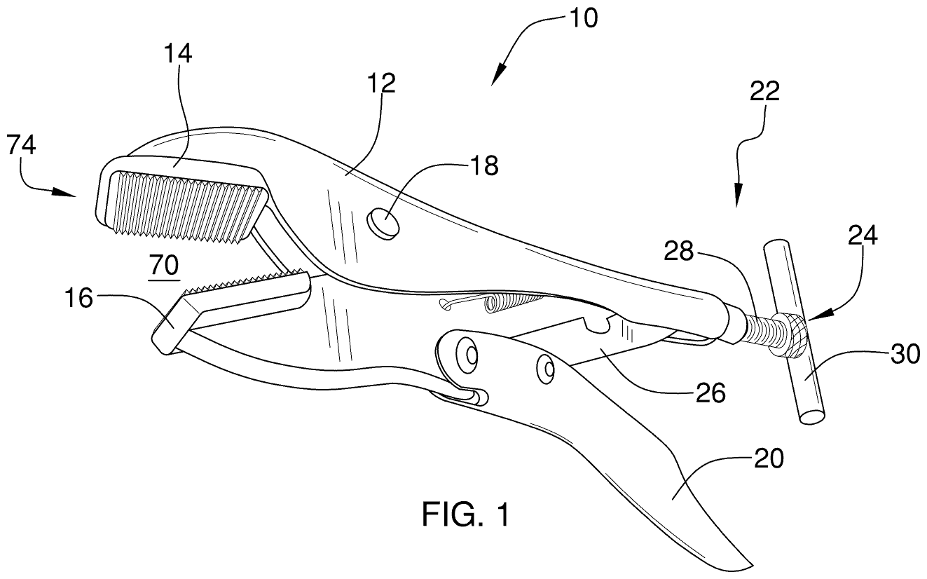

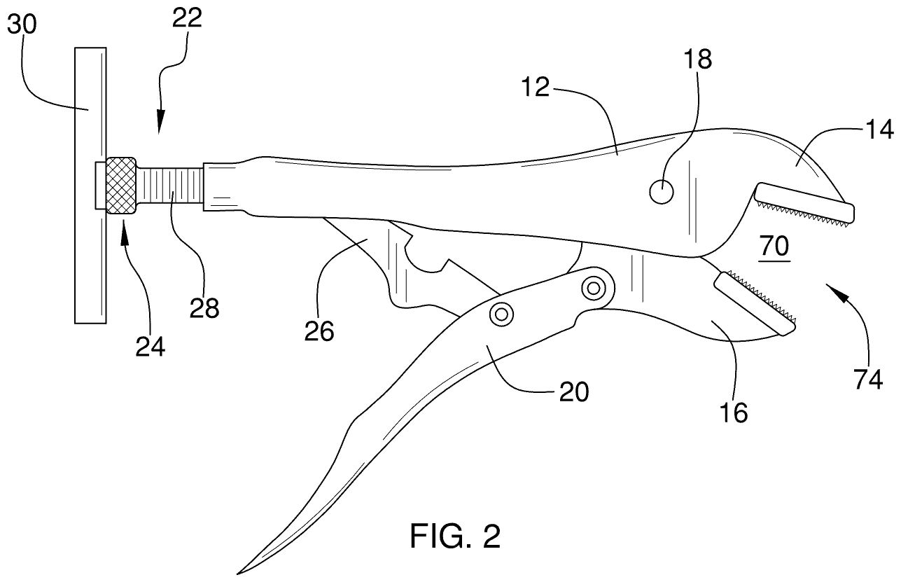

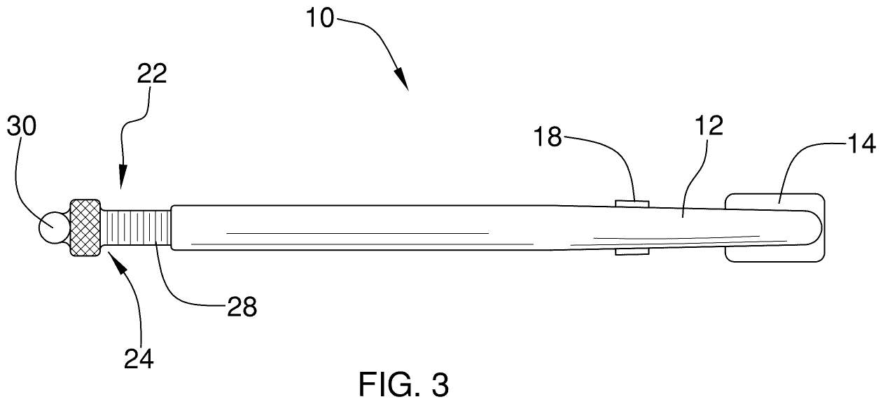

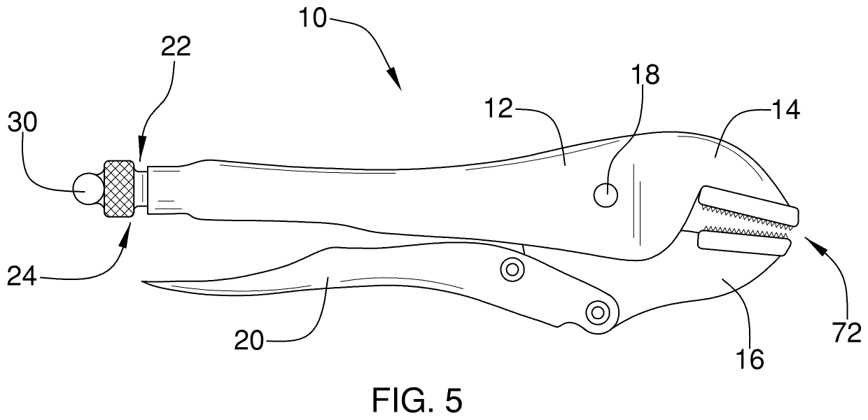

With reference now to the drawings, and in particular to FIGS. 1 through 6 thereof, a new adjustable pair of locking pliers embodying the principles and concepts of an embodiment of the disclosure and generally designated by the reference numeral 10 will be described.

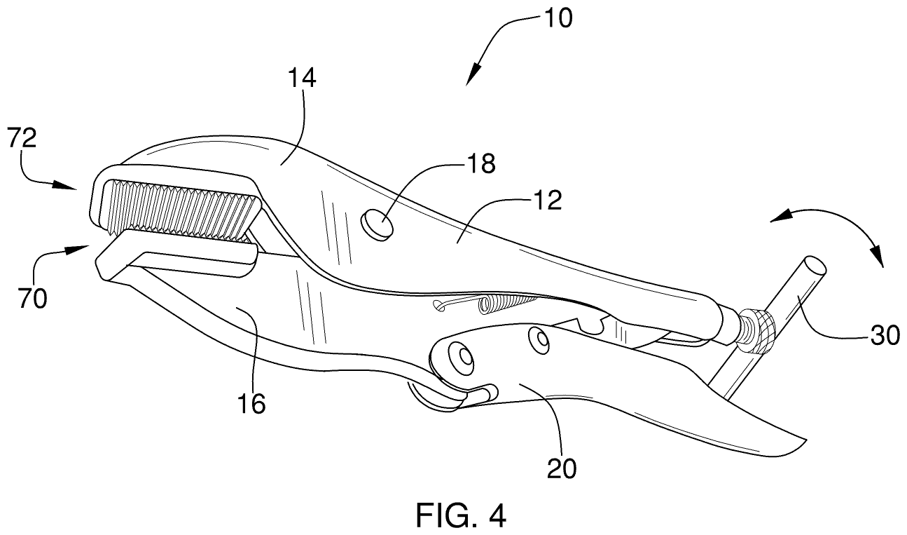

As best illustrated in FIGS. 1 through 6, the adjustable pair of locking pliers 10 generally comprises a fixed handle 12 that includes an upper jaw 14, a lower jaw 16 pivotably connected to the fixed handle 12 by a pivot joint 18, a movable handle 20 pivotably connected to the lower jaw 16, and an adjustment assembly 22. The adjustment assembly 22 is designed to permit adjustment of the gripping space 70 between the upper and lower jaws 14, 16 when in a clamping position 72. The clamping position 72 is shown in FIGS. 4 through 6, which is the position in which the upper and lower jaws 14, 16 are brought close together, which is in contrast to the open position 74 shown in FIGS. 1 through 3. These positions 72, 74 are well known for standard locking pliers.

The adjustment assembly 22 includes an adjustment screw 24 positioned in an end portion of the fixed handle 12 and a locking piece 26 operatively connecting the movable handle 20 to the adjustment screw 24 and designed to releasably lock the upper and lower jaws 14, 16 under tension in the clamping position 72 on an object 76. The adjustment screw 24 includes a threaded body 28 and a handle 30 positioned transverse to the threaded body 28 and designed to be manually grasped and twisted by a user to advance and retract the threaded body 28 to both set the gripping space 70 and release the upper and lower jaws 14, 16 from a locked state.

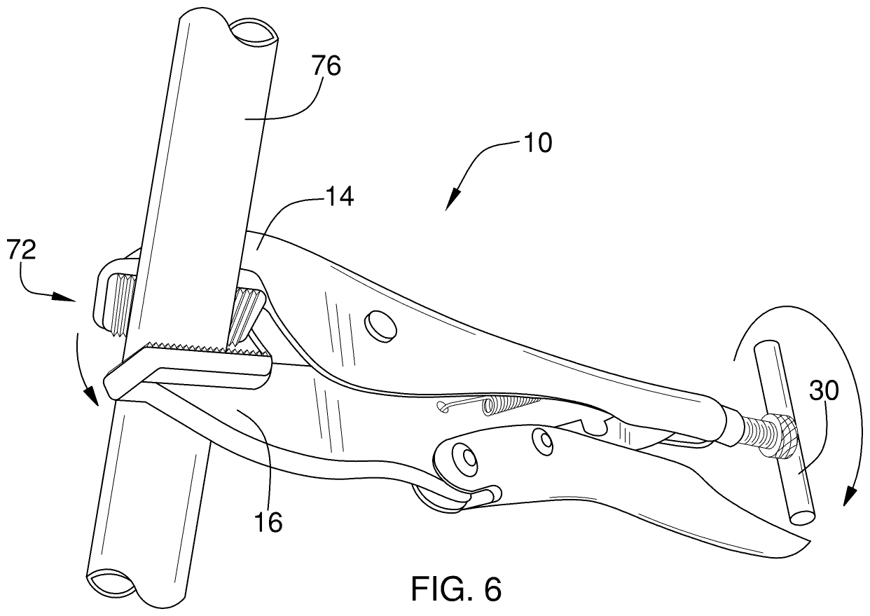

To use the adjustable pair of locking pliers 10, as shown in FIG. 4, the user twists the handle 30 and advances or retracts the threaded body 28 until the gripping space 70 between the upper and lower jaws 14, 16 when in the clamping position 72 is at a selected width. As shown in FIG. 6, the user then places the upper and lower jaws 14, 16 around an object 76 and then presses the movable handle 20 and the fixed handle 12 together to clamp the upper and lower jaws 14, 16 onto the object 76. As a result, the locking piece 26 is moved into a locking position to releasably lock the upper and lower jaws 14, 16 under tension in the clamping position 72 on the object 76. This is a similar adjustment process as currently performed with standard locking pliers. When the user has finished using the adjustable pair of locking pliers 10 or wishes to change the clamping position 72, the user twists the handle 30, as shown by the arrow in FIG. 6, and retracts the threaded body 28, thereby increasing the gripping space 70 and releasing the tension and unlocking the lower jaw 16. The user then can remove the adjustable pair of locking pliers 10 from the object 76.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An adjustable pair of locking pliers comprising:
a fixed handle comprising an upper jaw;
a lower jaw pivotably connected to said fixed handle by a pivot joint;
a movable handle pivotably connected to said lower jaw; and
an adjustment assembly to permit adjustment of the gripping space between said upper and lower jaws when in a clamping position, wherein:
said adjustment assembly comprises an adjustment screw disposed in an end portion of said fixed handle and a locking piece operatively connecting said movable handle to said adjustment screw and configured to releasably lock said upper and lower jaws under tension in the clamping position on an object, and
said adjustment screw comprises a threaded body and a handle transverse to said threaded body and configured to be manually grasped and twisted by a user to advance and retract said threaded body to both set the gripping space and release said upper and lower jaws from a locked state.

2. The adjustable pair of locking pliers of claim 1, wherein said handle comprises a T-bar extending essentially radially in opposite directions from said threaded body.

3. The adjustable pair of locking pliers of claim 2, wherein said T-bar has a length approximately four to six times the diameter of said threaded body.

4. The adjustable pair of locking pliers of claim 1, wherein said adjustment screw comprises the sole means for releasing said upper and lower jaws from a locked state.

5. The adjustable pair of locking pliers of claim 2, wherein said adjustment screw comprises the sole means for releasing said upper and lower jaws from a locked state.

6. The adjustable pair of locking pliers of claim 3, wherein said adjustment screw comprises the sole means for releasing said upper and lower jaws from a locked state.

7. A method of using the adjustable pair of locking pliers of claim 1, comprising the steps of:
twisting said handle and advancing or retracting said threaded body until the gripping space between said upper and lower jaws when in the clamping position is at a selected width;
placing said upper and lower jaws around an object and then pressing said movable handle and said fixed handle together to clamp said upper and lower jaws onto the object, and thereby moving said locking piece into a locking position to releasably lock said upper and lower jaws under tension in the clamping position on the object;
twisting said handle and retracting said threaded body and thereby increasing the gripping space and releasing the tension and unlocking said lower jaw; and
removing the adjustable pair of locking pliers from the object.
